(19) United States
(12) Patent Application Publication
(10) Pub. No.: US 2005/0127145 A1
(43) Pub. Date: Jun. 16, 2005

(54) Metallic foam

(75) Inventors: Michael J. Czaplicki, Rochester, MI (US); David Carlson, Rochester Hills, MI (US); Brandon Madaus, Shelby Township, MI (US)

Correspondence Address: DOBRUSIN & THENNISCH PC, 29 W LAWRENCE ST, SUITE 210, PONTIAC, MI, 48342, US

(73) Assignee: L&L Products, Inc., Romeo, MI (US)

(21) Appl. No.: 10/967,783

(22) Filed: Oct. 18, 2004

Related U.S. Application Data
(60) Provisional application No. 60/523,707, filed on Nov. 20, 2003.

(51) Int. Cl. B23K 28/00

(52) U.S. Cl. 228/235.2

(57) ABSTRACT

There is disclosed a metallic foam and a method of forming a metallic foam such as an aluminum foam. There is also disclosed a method of using the metallic foam.

### CLAIM OF BENEFIT OF FILING DATE

The present application claims the benefit of the filing date of U.S. Provisional Application Ser. No. 60/523,707, filed Nov. 20, 2003, hereby incorporated by reference.

### FIELD OF THE INVENTION

The present invention relates generally to metallic foam including a method of forming metallic foam and a method of using metallic foam.

### BACKGROUND OF THE INVENTION

Metallic foam such as aluminum foam has been produced for many years and has several different known uses. However, processes for forming such foam and the foam formed by such processes suffer from a variety of drawbacks. As one example, the processes for forming metallic foam are typically costly and labor intensive. As another example, the ability to form metallic foams of desired shapes can be quite limited thereby limiting the potential uses of the foams. Thus, the present invention seeks to provide a metallic foam, a method of forming the metallic foam, a method of using the metallic foam or a combination thereof, which overcomes one or more of these or other drawbacks related to metallic foam.

### SUMMARY OF THE INVENTION

A method of forming a baffling or reinforcement member and a method of reinforcing or baffling a structure of an automotive vehicle are disclosed. Generally, the reinforcement or baffling member is formed by forming a carrier member from a metallic foam. In one embodiment, the carrier member is formed by providing a plurality of metallic layers. In the embodiment, pre-cells are formed between a first layer and a second layer of the plurality of layers and between a second layer and a third layer of the plurality of layers. The pre-cells are then expanded into cells by a process selected from providing the pre-cells with compressed gas or expanding an expansion material within the pre-cells for forming the carrier member. Typically, an expandable material is disposed upon an exterior surface of the carrier member for forming the baffling or reinforcement member.

For reinforcing or baffling a structure of the automotive vehicle, the reinforcement member is typically positioned within a cavity of or adjacent to the structure of the automotive vehicle. Thereafter, the expandable material is expanded and adhered to walls of the structure wherein the walls can at least partially define the cavity.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of a plurality of metallic layers having a barrier material applied thereto.

FIG. 2 is a perspective view of the plurality of metallic layers of FIG. 1 after lamination of the layers together.

FIG. 3 is a perspective view of a plurality of metallic layers having an expandable barrier material applied thereto.

FIG. 4 is a perspective view of the plurality of metallic layers of FIG. 3 after lamination of the layers together.

FIG. 5 is a perspective view of a plurality of metallic layers having openings defined therein.

FIG. 6 is a perspective view of the plurality of metallic layers of FIG. 5 after lamination of the layers together.

FIGS. 7-9 are perspective views of metallic foams formed in accordance with the present invention.

FIG. 10 is a perspective view of an exemplary member of the present invention being inserted into a structure.

FIG. 11 is a perspective view of another exemplary member of the present invention being inserted into a structure.

### DETAILED DESCRIPTION OF THE PREFERRED EMBODIMENT

The present invention is predicated upon the provision of a metallic foam, a method for making the metallic foam, a method of using the metallic foam or a combination thereof. Although it is contemplated that the metallic foam of the present invention may be employed for a variety of uses, it has been found that the foam is particularly suitable for providing baffling, sealing, reinforcing or a combination thereof to an article of manufacture such as a building, an appliance, a home, furniture or the like. Even more particularly, it has been found that the metallic foam is particularly suitable for providing baffling, sealing, reinforcing or a combination thereof to transportation vehicles such as boats, trains, automotive vehicles.

The method of forming the metallic foam typically includes:
i) providing a plurality of metallic layers (e.g., metallic sheets);
ii) forming pre-cells between the metallic layers; and
iii) expanding each of the pre-cells to form cells.

The metallic layers of the metallic foam can be provided in a variety of different shapes and configurations as long as one layer can be laminated to another layer. Moreover, the metallic layers may include a variety of different materials depending upon the desired properties of the metallic foam. For example, the metallic layers may be entirely metal or may be composite materials. Typically, the layers will include a substantial portion of metal such as steel, iron, magnesium, titanium, combinations thereof or the like. It has been found, however, that layers including a substantial amount of aluminum are particularly useful for the present invention.

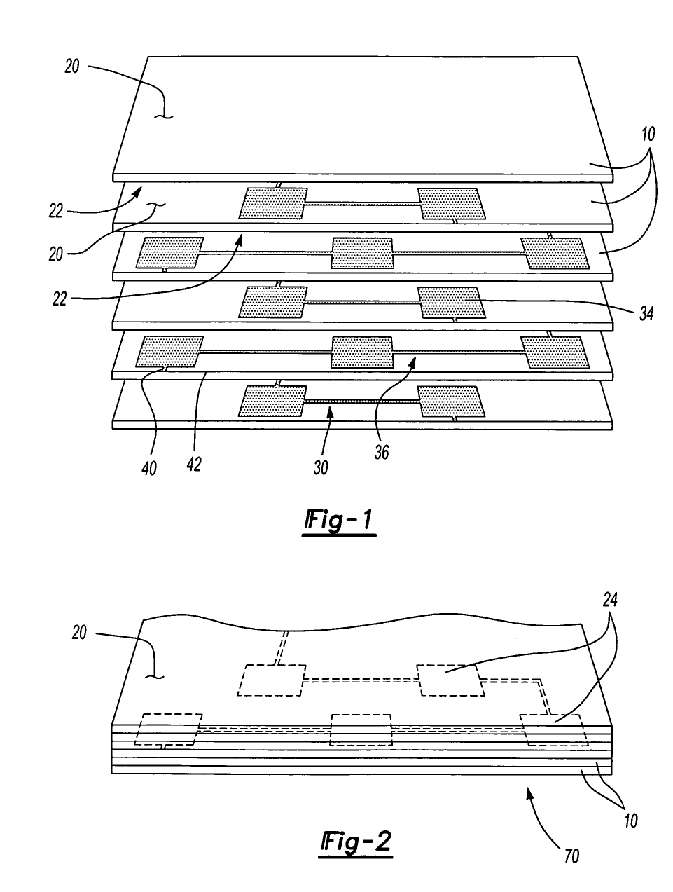

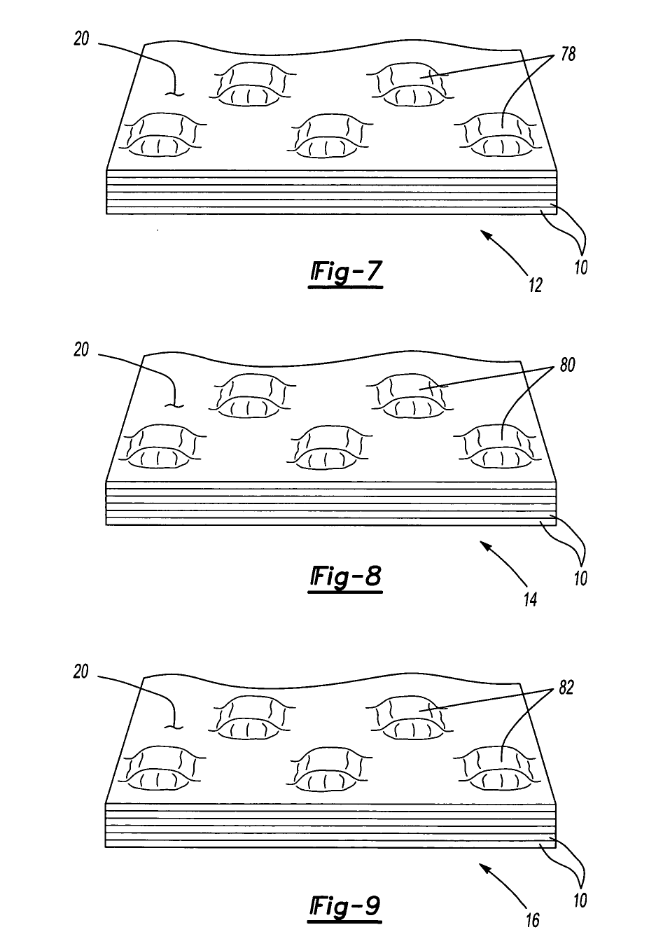

In each of FIGS. 1-6, there is illustrated a plurality of exemplary metallic layers 10, which may be employed for forming metallic foams 12, 14, 16 as shown in FIGS. 7-9. Generally, the metallic layers 10 in each of FIGS. 1-6 are substantially the same although each may be processed according to different techniques to form the metallic foams 12, 14, 16. Although, the plurality of layers 10 can include as few as two layers 10, the foam of the present invention is preferably formed with at least three layers 10 and more preferably at least five layers 10 or more.

Each of the layers 10 is illustrated as a sheet of metallic material. In particular, each layer 10 preferably includes a substantial amount (i.e., at least 50% by weight) of aluminum and, more preferably, is substantially entirely (i.e., at least 80% by weight) formed of aluminum. The layers 10 may be a foil with some flexibility or may be relatively rigid. The layers 10 are typically at least about 0.01 mm, more typically at least about 0.1 mm and more typically at least about 0.6 mm in thickness and are typically no greater than about 15 mm, more typically no greater than about 5 mm and more typically no greater than about 2 mm thick.

In the embodiment depicted, each layer 10 has a first surface 20 opposite a second surface 22 with a thickness therebetween. Each layer 10 preferably has a uniform thickness although the thickness may be variable. The thickness of each layer 10 is typically between about 3 mm and about 0.01 mm, more typically between about 1 mm and about 0.03 and even more typically between about 0.10 mm and about 0.05 mm. Moreover, the layers can be shaped as desired and, according to one embodiment, can be shaped in a predetermined manner to produce a metallic foam of a desired shape.

For forming the metallic foam, the layers 10 are preferably laminated together such that one or more first surfaces 20 of the layers 10 bonds to one or more second surfaces 22 of the layers 10 for forming a stack of the layers 10. Lamination may be achieved by roll bonding or other techniques as will be further described below.

Upon lamination, however, a plurality of pre-cells 24 is preferably formed between the metallic layers 10 as shown in FIGS. 2, 4 and 6. As used herein, the term pre-cells refers to spaces between laminated layers whether filled or empty wherein bonding of the layers 10 has been prohibited or substantially limited. Generally, the pre-cells 24 can be formed using a variety of techniques, although some may be more desirable depending upon the intended use of the metallic foam. FIGS. 1, 3 and 5 are provided to illustrate three different techniques for forming the pre-cells 24 of FIGS. 2, 4 and 6.

In FIG. 1, patterns 30 of barrier material have been disposed upon the first surfaces 20, the second surfaces 22 or both of one or more of the layers 10. In the embodiment shown, the patterns 30 include relatively expansive masses 34 (e.g., shown as rectangles) of material interconnected by relatively thin connection portions 36. The patterns 30 may also include an access portion 40 extending from at least one of the masses 34 or connection portions 36 of the pattern 30 to an edge 42 of the layer 10. Preferably, each of the masses 34 cover a surface area of either the first surfaces 20, the second surfaces 22 or both of between about 1000 cm² to about 0.1 cm², more preferably about 100 cm² to about 0.8 cm² and even more preferably about 30 cm² to about 3 cm².

Of course, it is contemplated that various patterns of barrier material may be applied to the layers and may be applied in various shapes and sizes. Moreover, the barrier material may be selected from large numbers of different materials. Examples include polymeric material, metals, ceramics, graphite materials, combinations thereof or the like. Moreover, several techniques may be employed for patterning the barrier material upon the layers 10. One technique is silk screening. Other techniques include forming the pattern follow by adhering the pattern to the layers 10. Still another technique includes extruding the material onto the layers 10.

In one embodiment, it may be desirable for the barrier material to be or to include an expansion material. As used herein, an expansion material is intended to mean any material that can expand a pre-cell into a cell. Preferably, the expansion material forms a gas from one or more non-gas materials (e.g., liquids or solids) for expanding the pre-cells.

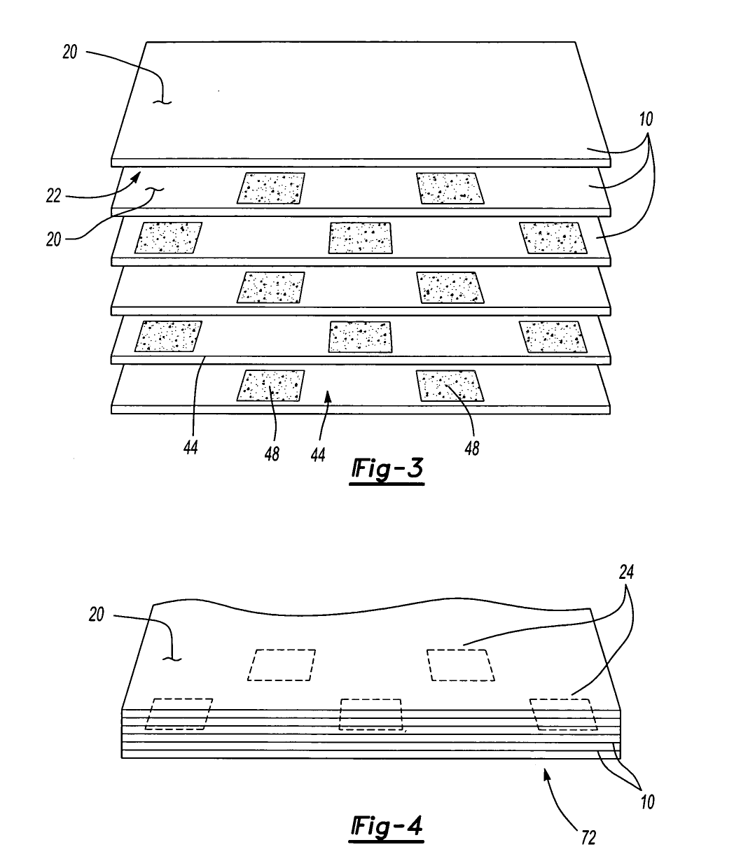

With reference to FIG. 3, patterns 44 of material, which are or include an expansion material, have been disposed upon the first surfaces 20, the second surfaces 22 or both of the layers 10. In the embodiment shown, the patterns 44 include expansible masses 48 substantially identical to the masses 34 of the pattern 30 of FIG. 1, however, the connection portions 36 and the access portions 40 have been removed. Of course, it is contemplated that the connection portions 36 and the access portions 40 may be part of the pattern 44 as well, however, as further described below, they are unneeded in the embodiment of FIG. 3. It is further contemplated that the shape, size and configuration of the masses 48 or pattern 44 of FIG. 2 may be varied as described with respect to FIG. 1.

The expansion material may be formed of a variety of suitable materials. In one embodiment, the expansion material may be a blowing agent, which as defined herein means, a material that can be activated to expand upon exposure to a stimulus such as heat, moisture, pressure or the like. Generally, the blowing agents may be physical, chemical or a combination thereof. As an example of a physical blowing agent, the barrier material may include an encapsulation that encloses a liquid or gas that expands upon exposure to heat or other stimulus to expand.

Typically, the blowing agent will be chemical in nature and will undergo a chemical reaction upon exposure to a stimulus such as heat. Examples of heat activated chemical blowing agents include, without limitation, azodicarbonamide, dinitrosopentamethylenetetramine, 5-phenyltetrazole, 4,4ᵢ-oxy-bis-(benzenesulphonylhydrazide), trihydrazinotriazine and N,Nᵢ-dimethyl-N,Nᵢ-dinitrosoterephthalamide. Another possible blowing agent, which may be activated by exposure to heat or by moisture is titanium hydride.

An accelerator for the blowing agents may also be provided in the expandable material. Various accelerators may be used to increase the rate at which the blowing agents form inert gasses. One preferred blowing agent accelerator is a metal salt, or is an oxide, e.g. a metal oxide, such as zinc oxide. Other preferred accelerators include modified and unmodified thiazoles or imidazoles, ureas or the like.

As discussed, the expansion material may be part of the barrier material or may be the entire barrier material. As such, blowing agents comprising the expansion material may be applied to the layers 10 of aluminum by themselves to form the barrier material or may be applied as part of the barrier material. As an example, a blowing agent may be applied by itself as a solid (e.g. a powder) or as a liquid to a surface of the layers.

Typically, the expansion material will be added to (e.g., mixed into, layered upon or the like) one or more other ingredients such as a polymeric material, an adhesive material, a solid material (e.g., graphite), a combination thereof or the like. As one example, the expansion material (e.g., a blowing agent) will be adhesively secured to a material such as graphite for forming the barrier material.

In another embodiment, the expansion material may be part of an expandable polymeric barrier material. In one possible embodiment, the barrier material may be expandable to form a foam and may have a polymeric formulation that includes one or more of an epoxy, an acrylate, an acetate, an elastomer, a combination thereof or the like admixed with an expansion material (e.g., a blowing agent). For example, and without limitation, the polymeric materials of the barrier material may comprise an EVA/rubber-based material, an epoxy-based material or the like and may include an ethylene copolymer or terpolymer that may possess an alpha-olefin. One example of an expandable material suitable for use as the barrier material is disclosed in commonly owned copending U.S. patent application titled Expandable Material, attorney docket # 1001-141P1, filed on the same date as the present application and fully incorporated herein by reference for all purposes.

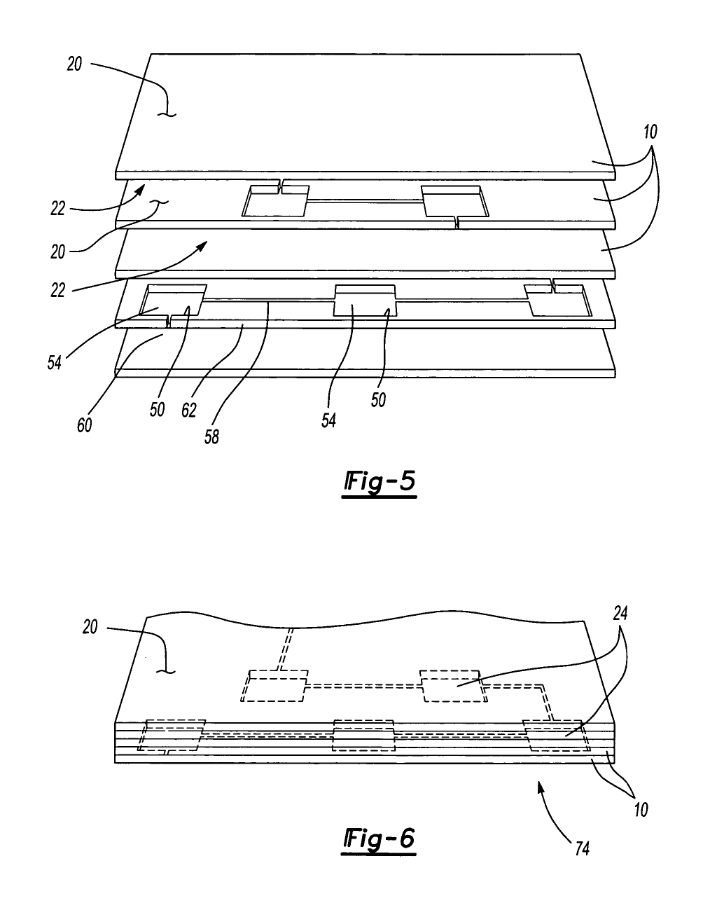

In yet another embodiment, pre-cells may be formed by providing openings (e.g., cavities, through-holes or the like) in one or more of the plurality of layers. With reference to FIG. 5, patterns 50 of openings 54 shown as rectangular through-holes have been formed within internal layers 10 of the plurality of layers 10. As shown, connecting portions are formed as connection channels 58 and access portions are formed as access channels 60 have also been formed within the internal layers 10 of the plurality of layers 10. Preferably, the connecting channels 58 interconnect the openings 54 of the pattern 50 while the access channels 60 preferably extend from at least one of the openings 54 or connecting channels 58 to an edge 62 of the layer 10. It is also contemplated that, in some embodiments, the connecting portion or channels and/or the access portions or channels may not be included.

In FIGS. 1 and 3, the patterns 30, 44 of barrier material, upon lamination of the layers 10, prevent bonding between directly adjacent layers 10 or surfaces 20, 22 of the layers 10 at the locations of the masses 34, 48, the connection portions 36, the access portions 40 or a combination thereof. At the same time, the patterns 30, 44 allow bonding of the layers 10 or the surfaces 20, 22 of the layers 10 surrounding the masses 34, 48, the connection portions 36, the access portions 40 or a combination thereof. In this manner, the pre-cells 24 of FIGS. 2 and 4 are formed.

In FIG. 5, the pattern 50, upon lamination of the layers 10, prevent bonding between next to adjacent layers 10 or surfaces 20, 22 of the next to adjacent layers 10 at the locations of the openings 54, the connection channels 58, access channels 60 or a combination thereof. At the same time, the pattern 50 allows bonding of directly adjacent layers 10 or surfaces 20, 22 of directly adjacent layers 10 substantially surrounding the openings 54, the connection channels 58, the access channels 60 or a combination thereof. In this manner, the pre-cells 24 of FIG. 6 can be alternatively formed.

Lamination of the layers 10 can be accomplished by a variety of techniques within the scope of the present invention, but is preferably accomplished by roll bonding or vacuum bonding as applied to the plurality of layers 10 illustrated. Examples of such bonding techniques are disclosed in U.S. Pat. Nos. 2,957,230; 3,340,589 and U.S. Patent Application Publication 2002/0033410, all of which are expressly incorporated by reference for all purposes.

As an example, the layers 10 can be pre-heated if needed or desired followed by feeding or supplying the layers 10 to rollers of a roll bonding machine. In turn, the rollers apply pressure, heat or both to the layers 10 thereby urging contact between the first and second surfaces 20, 22 of the layers 10 particularly at areas not covered by the barrier material. In turn, the contacting portions or surfaces bond to each other to form stacks 70, 72, 74 are respectively shown in FIGS. 2, 4 and 6.

When a expansion material is employed as at least part of the barrier material, lamination of the layers is preferably performed at a temperature that does not activate the expansion of the expansion material. Thus, expansion materials such as azodicarbonamide, dinitrosopentamethylenetetramine, 4,4ᵢ-oxy-bis-(benzenesulphonylhydrazide), trihydrazinotriazine and N, Nᵢ-dimethyl-N,Nᵢ-dinitrosoterephthalamide, a lower temperature process such as vacuum bonding. However, for expansion materials such as titanium hydrate with higher activation temperature, a higher temperature process such as roll bonding may be employed.

After lamination, the pre-cells are typically expanded to form cells thereby forming the metallic foam of the present invention. As discussed, an example of such foams 12, 14 and 16 respectively having expanded cells 78, 80, 82 are illustrated in FIGS. 7-9. Expansion of the pre-cells can be accomplished using a variety of techniques, some of which are disclosed below.

According to one embodiment, the pre-cells are expanded by providing pressurized fluid (e.g., air) to the pre-cells. When a barrier material as in FIG. 1 or openings as in FIG. 5 are employed, a source of pressurized fluid can be used to feed its fluid (e.g., air) to the pre-cells. In turn, the pre-cells can expand to form the cells 70, 74 as shown in FIGS. 7-9. In the embodiments shown, the fluid can be introduced at the access portions 40, 60 to flow to the connection portions 36, 58 and the pre-cells 24.

According to another embodiment, however, such as the embodiment of FIGS. 3, 4 and 8, the pre-cells 24 are expanded to form cells 72 by activating the pattern 44 of expansion material of the barrier material to expand. Generally, the expansion material may be expanded by applying any of the stimuli discussed herein (e.g., exposure to heat, exposure to moisture, chemical reaction or the like).

In a preferred embodiment, the expansion material is activated by applying heat. Activation temperatures may vary widely for different expansion materials. As an example, activation temperatures for expansion materials such as azodicarbonamide, dinitrosopentamethylenetetramine, 4,4ᵢ-oxy-bis-(benzenesulphonylhydrazide), 5-phenyltetrazole, trihydrazinotriazine and N,Nᵢ-dimethyl-N,Nᵢ-dinitrosoterephthalamide can range from about 140° C. to about 280° C. and more typically from 150° C. to about 170° C. or from about 200° C. to about 220° C. A typical activation temperature for titanium hydride or other like blowing agents can range from about 350° C. to about 550° C., more typically from about 410° C. to about 500° C. and even more typically from about 450° C. to about 475° C.

For automotive applications, it is contemplated that the expansion materials may be activated by temperatures typically encountered during painting or coating operations (e.g., e-coat) during assembly of the vehicles as further discussed below. Alternatively, for an expansion material such as titanium hydrate, it is contemplated that the layers of aluminum may include passages allowing moisture (e.g., from the painting or coating operations) to contact the expansion material and assist in activating the material at lower temperatures (e.g., temperatures typically encountered during painting or coating operations or lower) than are typically required for activation of such an expansion material. In these instances, a heating step separate from that normally used during the assembly of automotive vehicles may be removed from the process of the present invention.

Use

Generally, it is contemplated that metallic foam formed according to the present invention may be applicable to a wide variety of uses including any prior or future uses for conventional metallic foam. However, it has been found that metallic foam formed according to the present invention is particularly useful for providing reinforcing, sealing, sound attenuation, combinations thereof or the like to articles of manufacture such as buildings, furniture, transportation vehicles (e.g., boats, airplanes, automotive vehicles or the like).

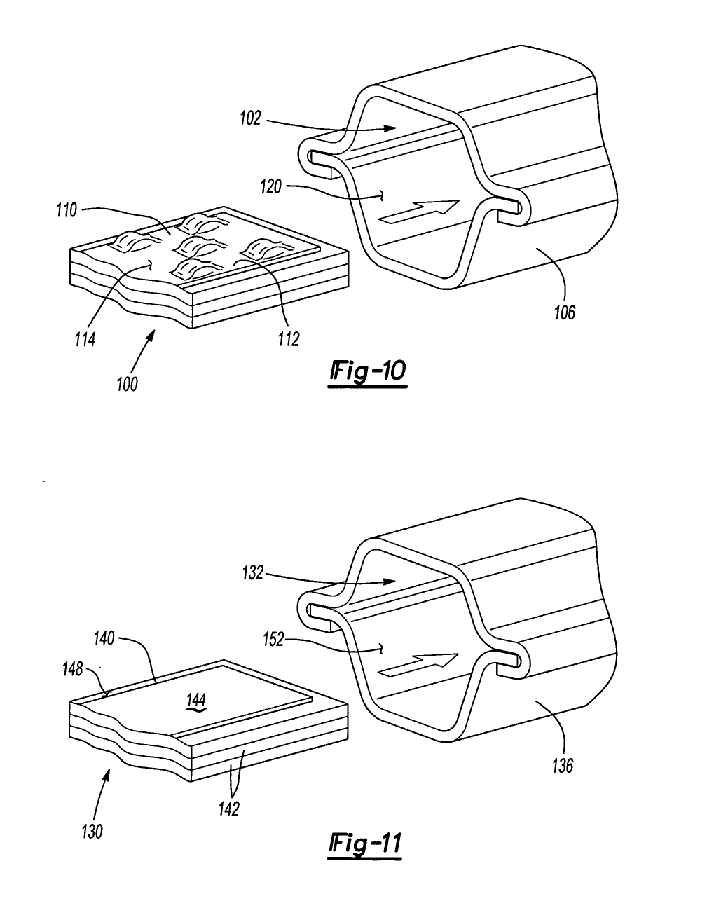

For exemplary purposes, and referring to FIGS. 10 and 11, metallic foams of the present invention are being applied to a structure (e.g., a pillar, a frame structure, a body structure, a roof structure, a roof rail, a hood structure, a trunk structure, combinations thereof or the like) of an automotive vehicle.

In FIG. 10, a reinforcement member 100 is being inserted into a cavity 102 of a structure 106 of an automotive vehicle. As can be seen, the reinforcement member 100 includes a carrier 110 that is formed of metallic foam according to the present invention. Additionally, the reinforcement member 100 includes an expandable material 112 disposed on one or more outer surfaces 114 of the carrier 110. The expandable material 112 is preferably configured to expand and become be a structural reinforcing foam, although not required.

In the embodiment shown, the metallic foam has already been formed with cells prior to insertion of the member 100 into the structure 106. Upon insertion, the member 100 can be held in place within the cavity 102 of the structure 106 using a variety of techniques such as adhesion, fastening, magnetism or the like until the expandable material 112 is activated to expand and cure. Upon activation, the expandable material 112 typically expands to contact and wet one or more walls 120 of the structure 106 and then cures to adhere the member 106 to the one or more walls 120 of the structure 106 thereby securing the member 100 in the cavity 102. In turn, the member 100 provides structural reinforcement, sealing, baffling, a combination thereof or the like to the structure 106.

In FIG. 11, another reinforcement member 130 is being inserted into a cavity 132 of a structure 136 of an automotive vehicle. As can be seen, the reinforcement member 130 includes a carrier 140 that is formed as a stack of metallic layers 142 with expandable barrier material forming pre-cells disposed between the layers 142 such as that which was described in FIG. 2. Additionally, the reinforcement member 130 includes an expandable material 144 disposed on one or more outer surfaces 148 of the carrier 140. The expandable material 144 is preferably configured to become a structural reinforcing foam, although not required.

In the embodiment shown, the carrier 140 has not yet been formed into metallic foam prior to insertion of the member 130 into the structure 136. Upon insertion, as previously discussed, the member 130 can be held in place within the cavity 132 of the structure 136 using a variety of techniques such as adhesion, fastening, magnetism or the like until the expandable material 144 on the outer surfaces 148 and the expandable barrier material between the layers 142 is activated to expand and cure. Upon activation, the expandable barrier material typically expands and cures to form cells from pre-cells as discussed with respect to FIG. 8. The expandable material 144 on the one or more outer surfaces 148, preferably at substantially the same time, typically expands to contact and wet one or more walls 152 of the structure 136 and then cures to adhere the member 130 to the one or more walls 152 of the structure 136 thereby securing the member 130 in the cavity 132. In turn, the member 130 provides structural reinforcement, sealing, baffling, a combination thereof or the like to the structure 136.

Advantageously, members such as those discussed with respect to FIGS. 11 and 12 can be shaped as needed or desired for reinforcing, sealing or baffling various differently shaped structures. Such shaping can be accomplished by shaping the layers of the metallic foam as desired prior to or after pre-cell expansion. Such shaping can also be accomplished by providing different amount of expansion for cells located in different locations of a member. Moreover, where expandable barrier material is employed, different amounts of barrier material may be located at different portions of the members to cause different levels of expansion where desired.

In embodiments having expansion of both the barrier material and the expandable material 144 on the outside of the member 130 after insertion into a structure of an automotive vehicle, it is preferable for the expansion material of the barrier material and the expandable material 144 on the outside of the member 130 to expand at temperatures typically encountered in coating or painting operations used during vehicle assembly. In such embodiments, the expandable materials on the outer surfaces such as the materials 114, 144 may be the same or different as that of the barrier material within the aluminum foam.

The expandable material 114, 144 may be formed of a variety of suitable materials and the material may be designed for structural reinforcement, baffling, sound absorption, sealing, a combination thereof or the like. Preferably, the expandable material is formed of a heat activated material having foamable characteristics. The material may be generally dry to the touch or tacky and may be shaped in any form of desired pattern, placement, or thickness, but is preferably of substantially uniform thickness.

Though other heat-activated materials are possible for the expandable material, a preferred heat activated material is a cross-linkable expandable polymer or plastic, and preferably one that is foamable. Examples of suitable expandable materials include L5206, L5207, L5208, L5218, L2105, L7102, L2603 and other materials that are commercially available from L&L Products of Romeo, Mich. Other examples of suitable expandable materials include high, medium or low expansion foams having a polymeric formulation that includes one or more of an epoxy, an acrylate, an acetate, an elastomer, a combination thereof or the like. For example, and without limitation, the foam may be an EVA/rubber based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules.

A number of baffling, reinforcing or sealing foams are known in the art and may also be used to produce the foam. A typical foam includes a polymeric base material, such as one or more ethylene-based polymers which, when compounded with appropriate ingredients (typically a blowing and curing agent), expands and cures in a reliable and predictable manner upon the application of heat or the occurrence of a particular ambient condition. From a chemical standpoint for a thermally-activated material, the foam, which may be structural or acoustical, is usually initially processed as a flowable material before curing, and upon curing, the material will typically cross-link making the material incapable of further flow.

One advantage of the preferred foam materials over prior art materials is that the preferred materials can be processed in several ways. The preferred materials can be processed by injection molding, extrusion compression molding or with a mini-applicator. This enables the formation and creation of part designs that exceed the capability of most prior art materials.

While the preferred materials for fabricating the expandable material has been disclosed, the expandable material can be formed of other materials provided that the material selected is heat-activated or otherwise activated by an ambient condition (e.g. moisture, pressure, time or the like) and cures in a predictable and reliable manner under appropriate conditions for the selected application. One such material is the epoxy based resin disclosed in U.S. Pat. No. 6,131,897, the teachings of which are incorporated herein by reference, filed with the United States Patent and Trademark Office on Mar. 8, 1999 by the assignee of this application. Some other possible materials include, but are not limited to, polyolefin materials, copolymers and terpolymers with at least one monomer type an alpha-olefin, phenol/formaldehyde materials, phenoxy materials, and polyurethane materials. See also, U.S. Pat. Nos. 5,766,719; 5,755,486; 5,575,526; and 5,932,680, (incorporated by reference). As other examples, the material could be a two-component expandable material such as an epoxy/amine material, an epoxy/acid material, a polyurethane/isocyanate material or the like wherein one component is kept separate from the other until expansion or foaming is desired. Preferably, the material has good adhesion durability properties for providing a well-bonded baffle and does not generally interfere with the materials systems employed by automobile or other manufacturers.

In applications where the expandable material is a heat activated, thermally expanding material, an important consideration involved with the selection and formulation of the material comprising the foam is the temperature at which a material reaction or expansion, and possibly curing, will take place. Typically, the foam becomes reactive at higher processing temperatures, such as those encountered in an automobile assembly plant, when the foam is processed along with the automobile components at elevated temperatures or at higher applied energy levels, e.g., during paint curing steps. While temperatures encountered in an automobile assembly operation may be in the range of about 148.89° C. to 204.44° C. (about 300° F. to 400° F.), body and paint shop applications are commonly about 120° C. (about 240° F.), but may be higher or lower. If needed, blowing agent activators can be incorporated into the composition to cause expansion at different temperatures outside the above ranges. Generally, suitable expandable foams have a range of expansion ranging from approximately 0 to over 1000 percent.

In another embodiment, the expandable material is provided in an encapsulated or partially encapsulated form, which may comprise a pellet, which includes an expandable foamable material, encapsulated or partially encapsulated in an adhesive shell. An example of one such system is disclosed in commonly owned, co-pending U.S. application Ser. No. 09/524,298 (“Expandable Pre-Formed Plug”), hereby incorporated by reference.

It is contemplated that the expandable material could be delivered and placed into contact with the coating material, the layers or a structure, through a variety of delivery systems which include, but are not limited to, a mechanical snap fit assembly, extrusion techniques commonly known in the art as well as a mini-applicator technique as in accordance with the teachings of commonly owned U.S. Pat. No. 5,358,397 (“Apparatus For Extruding Flowable Materials”), hereby expressly incorporated by reference. In this non-limiting embodiment, the material or medium is at least partially coated with an active polymer having damping characteristics or other heat activated polymer, (e.g., a formable hot melt adhesive based polymer or an expandable structural foam, examples of which include olefinic polymers, vinyl polymers, thermoplastic rubber-containing polymers, epoxies, urethanes or the like) wherein the foamable or expandable material can be snap-fit onto the chosen surface or substrate; placed into beads or pellets for placement along the chosen substrate or member by means of extrusion; placed along the substrate through the use of baffle technology; a die-cast application according to teachings that are well known in the art; pumpable application systems which could include the use of a baffle and bladder system; and sprayable applications.

The expandable material may be any of the expandable materials disclosed herein. In one embodiment, the expandable material is a material that experiences relatively high levels of expansion upon exposures to temperatures of between about 148.89° C. to 204.44° C. (about 300° F. to 400° F.) (i.e., temperatures typically experienced in automotive painting or coating operations). Accordingly, the preferred expandable material can be configured to have a volumetric expansion of at least about 1500%, more preferably at least about 2000%, even more preferably at least about 2500% and still more preferably at least about 3000% its original or unexpanded volume. An example of such an expandable material with such expansion capabilities is disclosed in commonly owned copending U.S. patent Application titled Expandable Material, attorney docket # 1001-141 P1, filed on the same date as the present application and fully incorporated herein by reference for all purposes. Of course, in other embodiments, the expandable material may be configured to have less volumetric expansion. For example, the expandable material may be configured to expand to at least 10% or less, more preferably at least 100% and even more preferably at least 300% and still more preferably at least 500% or 750% its original or unexpanded volume.

In addition to the above, it is contemplated that the various layers may have different thicknesses. For example, a central layer (i.e., a layer sandwiched between two other layers) may be thicker than other layers for forming a strengthening rib through carrier formed with the layers. As another example, one or more outer layers (i.e., layers that would form the outer surfaces of a carrier) may be thicker than inner or sandwiched layers for forming a thicker outer skin for the carrier. In such embodiments, the thicker layer will typically be at least 0.01 mm, more typically 0.1 mm and even more typically 0.5 mm thicker than the thinner layers.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. A method of forming a metallic foam reinforcement of baffling member, the method comprising:
providing a plurality of metallic layers wherein the plurality of metallic layers includes at least three layers and wherein each of the metallic layers is aluminum based;
forming pre-cells between a first layer and a second layer of the at least three layers and between a second layer and a third layer of the at least three layers;
expanding each of the pre-cells into cells by a process selected from providing the pre-cells with compressed gas or expanding an expansion material within the pre-cells.

2. A method as in claim 1 wherein each of the at least three layers has a thickness of at least about 0.1 mm but no greater than about 5 mm.

3. A method as in claim 1 wherein the pre-cells are at least partially formed upon bonding the first layer to the second layer and the second layer to the third layer.

4. A method as in claim 3 wherein the first layer is bonded to the second layer using a roll bonding technique.

5. A method as in claim 1 wherein the pre-cells are expanded into cells by expanding the expansion material and wherein the expansion material expands at a temperature experienced during an automotive coating process step.

6. A method as in claim 1 further comprising applying an expandable reinforcement baffling material to an exterior of the carrier member.

7. A method as in claim 1 wherein the at least three layers include at least five layers.

8. A method as in claim 1 wherein the pre-cells are formed by disposing masses of barrier material between the at least three layers.

9. A method as in claim 1 further comprising forming connection portions between the pre-cells.

10. A method of reinforcing or baffling a structure of an automotive vehicle, comprising:
forming a carrier member from metal foam;
disposing an expandable material upon the carrier member for forming a reinforcement member;
positioning the reinforcement member within a cavity of the structure of the automotive vehicle;
expanding and adhering the expandable material to walls of the structure wherein the walls at least partially define the cavity.

11. A method as in claim 10 wherein the metal foam is aluminum based.

12. A method as in claim 10 wherein the expandable material is a reinforcement material.

13. A method as in claim 10 wherein the carrier member has a relatively thick outer skin.

14. A method as in claim 10 wherein the carrier member includes a rib.

15. A method as in claim 10 wherein the metal foam is formed of multiple layers each layer having a substantial amount of aluminum.

16. A method as in claim 15 wherein the layers are bonded to each other using a roll-bonding technique.

17. A method as in claim 10 wherein the carrier member includes either a rib or a relatively thick skin.

18. A method of reinforcing a structure of an automotive vehicle, comprising:
providing a plurality of metallic layers wherein the plurality of layers includes at least three layers and wherein each of the metallic layers includes a substantial amount of aluminum;
forming pre-cells between a first layer and a second layer of the at least three layers and between a second layer and a third layer of the at least three layers;
expanding each of the pre-cells into cells by a process selected from providing the pre-cells with compressed gas or expanding an expansion material within the pre-cells for forming a carrier member;
disposing an expandable reinforcement material upon an exterior surface of the carrier member for forming a reinforcement member;
positioning the reinforcement member within a cavity of the structure of the automotive vehicle; and
expanding and adhering the expandable reinforcement material to walls of the structure wherein the walls at least partially define the cavity.

19. A method as in claim 18 wherein the pre-cells are formed by disposing masses of barrier material between the at least three layers.

20. A method as in claim 19 further comprising forming connection portions between the pre-cells.
